(19) United States
(12) Patent Application Publication
(10) Pub. No.: US 2009/0293568 A1
(43) Pub. Date: Dec. 3, 2009

(54) SOLID FUEL FROM BROWN GREASE AND METHODS AND SYSTEMS FOR BROWN GREASE AND SEWAGE SLUDGE RECYCLING

(75) Inventor: Steven J. Macchio, Dix Hill, NY (US)

Correspondence Address: NIXON PEABODY LLP - PATENT GROUP, 1100 CLINTON SQUARE, ROCHESTER, NY, 14604, US

(73) Assignee: DESTEGO BOATS, INC., Islandia, NY (US)

(21) Appl. No.: 12/537,694

(22) Filed: Aug. 7, 2009

Related U.S. Application Data
(62) Division of application No. 11/494,165, filed on Jul. 27, 2006.

(51) Int. Cl. C05F 3/04; B01J 8/00

(52) U.S. Cl. 71/12; 422/187

(57) ABSTRACT

A method and system for making solid fuel from brown grease includes providing brown grease, dewatering the brown grease, and combining the dewatered brown grease with a combustible material under conditions effective to make a solid fuel. A method and system for making a fertilizer material from sewage sludge includes providing sewage sludge, providing steam generated by combusting a fuel comprising brown grease, and contacting the sewage sludge with the steam under conditions effective to dewater the sewage sludge and render a fertilizer material.

This application is a divisional of U.S. patent application Ser. No. 11/494,165, filed Jul. 27, 2006, which is hereby incorporated by reference in its entirety.

### FIELD OF THE INVENTION

The present invention generally relates to methods and systems for recycling grease and sewage sludge and, more particularly, to methods and a system for making a solid fuel from brown grease and solid fuels thereof, as well as a method and system for making a fertilizer material from sewage sludge.

### BACKGROUND

Brown grease, generally known as trap grease, is a waste product generated in large part by food preparation and food services facilities. Failure to properly collect, remove, and dispose of brown grease at these and other facilities can result in accumulation in building piping, municipal collection systems, wastewater treatment plants, and onsite system drain fields. These accumulations can cause blockage and are known to frequently interfere with subsequent treatment plant sludge disposal or pass through treatment plants fouling discharge waters. Accumulated brown grease can also plug up trickling filters and other process equipment and has been known to kill drainage fields vital to the disposal process. Escaping brown grease in outflow and sludge can serve as transport and growth support for pathogenic organisms, resulting in contamination of lakes, rivers, beaches, and groundwater.

In view of these hazards, public health and safety laws regulate the collection, removal, and disposal of brown grease from brown grease generating facilities. These regulations typically require that brown grease be collected, removed, and properly disposed of. Collection of brown grease waste is generally carried out in on-site grease traps, grease interceptors, and/or other grease removal devices. Grease traps are relatively small devices hooked directly to the outgoing drains of sinks and dishwashers and are generally located inside the food preparation or food services facilities. Because they hold relatively small quantities of captured grease, these traps must be emptied and cleaned on a regular basis to avoid overflow. Grease interceptors are relatively large underground devices usually located outside the brown grease generating facility and are connected to the outgoing sewer drainage system. Grease interceptors must also be regularly emptied and cleaned.

Removal of brown grease from collection devices is typically performed by commercial septic haulers, which transport the collected brown grease to a proper disposal site. Disposal of brown grease generally requires that the brown grease be processed so that it can no longer enter the environment (water, soil, or air) in a form or quantity as to be deleterious. The most widely used methods of brown grease disposal include composting, caking for landfill deposit, land application, incineration, and blending or treating the brown grease at municipal treatment works.

Collecting, removing, and disposing of accumulated brown grease can be an expensive operation. Typically, producers of brown grease waste hire a private commercial waste hauler to regularly empty and clean grease removal devices and transport the brown grease to a suitable disposal site. With recent increases in fuel prices, transporting collected brown grease to disposal sites has placed increased economic burdens on both the commercial septic haulers and the food preparation and food services facilities that generate brown grease waste and pay for the transportation and disposal services. The most widely used disposal methods can cost as much as 20 cents to 85 cents per gallon depending upon locale and disposal options available. Thus, as fuel and energy prices continue to rise and as generation of brown grease waste continues to increase, there is a need to develop cost-effective methods and systems for brown grease disposal.

Bioremediation methods for brown grease disposal have recently been suggested as an alternative to traditional methods of brown grease collection, removal, and disposal. Onsite bioremediation refers to bioremediation at the site of brown grease generation prior to removal to a disposal site. Bioremediation systems are essentially a septic tank-drain field combination. The advantages of bioremediation of brown grease include (i) elimination of the need for frequent cleaning and disposal of brown grease; (ii) reduction of the brown grease pollutant to its basic elements (carbon, hydrogen and oxygen), usually in the forms of carbon dioxide and water; and (iii) removal of food scraps from facility effluent for useful by-products. However, bioremediation systems require complex engineering to develop tailored systems and can be expensive to operate and maintain.

Recycling methods and systems are also being developed as alternatives to traditional methods and systems of brown grease disposal. For example, a process for separating grease trap waste and other restaurant and commercial grease waste into their principal components, namely grease, water and solids, and reclaiming at least the solids and grease components has previously been disclosed in U.S. Pat. No. 5,225,085 to Napier et al. The solids from this process are said to have substantial commercial value usable in animal and pet foods.

Another technique for recycling brown grease is described in U.S. Patent Application Publication No. 2003/0201226 to Kelly, which discloses a process and apparatus for the treatment of septage, particularly grease trap waste. According to this process, septage is treated upon arrival at the processing facility by screening and grinding the raw septage. After the initial treatment, the septage is stored within a receiving tank prior to being transferred to a pasteurization tank. The septage is pasteurized by the introduction of steam into the tanks. After pasteurization, the septage is transferred to cooling tanks. The cooled pasteurized septage is then transferred to filter press feed tanks where it is treated with an alkali substance such as lime. The added alkali acts as a filter aid and allows the septage to be more easily dewatered into a good filter cake. The resulting lime conditioned septage slurry is pumped through filter presses that separate the solids from the liquid. Sludge dropped from the filter presses is said to have beneficial use as a biosolid to provide nutrients to growing vegetation or to improve the quality of soil for the purpose of growing vegetation.

Accordingly, to date brown grease recycling methods have focused on disposal of brown grease by generating foodstuff and biosolid materials for agricultural use. There continues to be a need for cost-effective methods and systems for recycling brown grease waste that provide adequate and proper disposal and produce revenue-generating products that help to reduce or eliminate the cost of collection, removal, and disposal.

Another waste product that could benefit from cost-effective recycling methods and systems is sewage sludge. Sewage sludge is a “solid” by-product of wastewater treatment systems, which must be removed from treated wastewater streams and undergo dewatering and drying procedures before being useable as a land application Biosolid fertilizer. The procedures of sewage sludge dewatering and drying typically involve mechanical dewatering systems and thermal drying operations.

One such thermal drying operation involves indirect contact dryers in which the heating of the sludge is indirectly affected by heating surfaces. Depending on the type of dryer, these heating surfaces possess the form of discs, paddles, rolls, and the like. Typically, the heating surfaces are steam-heated heating surfaces that heat the sludge until the moisture contained in the sludge evaporates. A ventilator or blower sucks away resulting exhaust vapors. The sludge dried in this manner is either applied to the heating surfaces in a thin layer and then abrased or scraped off, or the heating surfaces are moved or stirred in the product to be dried.

Generating the steam to heat the heating surfaces in these systems typically involves a fuel boiler that consumes large amounts of fuel. In view of increasing fuel costs, there continues to be a need for cost-effective and environmentally friendly fuel sources to provide the energy needed to recycle sewage sludge into commercially beneficial products, such as Biosolid fertilizer materials.

### SUMMARY

A method for making solid fuel from brown grease in accordance with embodiments of the present invention includes providing brown grease, dewatering the brown grease, and combining the dewatered brown grease with a combustible material under conditions effective to make a solid fuel.

A system for making solid fuel from brown grease in accordance with other embodiments of the present invention includes a dewatering unit and a mixing unit. The dewatering unit dewaters brown grease and the mixing unit combines the dewatered brown grease with a combustible material under conditions effective to make a solid fuel from the dewatered brown grease.

A solid fuel in accordance with other embodiments of the present invention includes brown grease and at least one combustible material combined with the brown grease to make a solid fuel.

A method for generating energy from brown grease in accordance with other embodiments of the present invention includes dewatering brown grease. The dewatered brown grease is combusted under conditions effective to generate energy.

A method for making solid fuel from brown grease in accordance with other embodiments of the present invention includes providing brown grease and dewatering the brown grease under conditions effective to make a solid fuel.

A solid fuel in accordance with other embodiments of the present invention includes dewatered brown grease.

A method of making a fertilizer material from sewage sludge in accordance with other embodiments of the present invention includes providing sewage sludge. Steam is provided by combusting a fuel containing brown grease. The sewage sludge is contacted with the steam under conditions effective to dewater the sewage sludge and render a fertilizer material.

A system for making fertilizer material from sewage sludge in accordance with other embodiments of the present invention includes a system for making solid fuel from brown grease, which includes a dewatering unit capable of dewatering brown grease under conditions effective to make a solid fuel. The system of the invention has a solid fuel boiler capable of combusting solid fuel from the system for making solid fuel to generate steam. The system also has a steam dryer for dewatering sewage sludge, where the steam dryer is coupled to the solid fuel boiler, whereby steam from the solid fuel boiler contacts the steam dryer thereby dewatering sewage sludge contained in the steam dryer to render a fertilizer material.

The present invention provides a number of advantages, including providing alternative, cost-effective methods and systems for disposal of brown grease waste. More specifically, the present invention helps meet the demands of disposing of an increasing amount of brown grease waste being generated by food processing and food services facilities, which is particularly significant in view of rising costs associated with brown grease waste disposal. Further, by providing safe and environmentally friendly methods and systems for utilizing the brown grease, the present invention helps prevent contamination of fresh water supplies and helps reduce the spread of harmful biological contaminates.

The present invention also provides methods and systems for not only disposing of brown grease, but making a revenue-generating solid fuel from this waste product. This solid fuel can be sold for profit or as explained herein can be utilized as a cost-effective energy source for making a fertilizer from sludge. This provides significant conservation benefits, as well as fuel cost savings at sludge-processing waste treatment facilities.

Accordingly, these and other advantages, which will be apparent to those of ordinary skill in the art, are provided by the present invention.

### BRIEF DESCRIPTION OF THE DRAWING

FIG. 1 is a block diagram of a system for making solid fuel from brown grease in accordance with embodiments of the present invention;

FIG. 2 is a flowchart of a method for making solid fuel from brown grease in accordance with embodiments of the present invention;

FIG. 3 is a block diagram of a system for making a fertilizer material from sewage sludge in accordance with embodiments of the present invention; and

FIG. 4 is a flowchart of a method for making a fertilizer material from sewage sludge in accordance with embodiments of the present invention.

### DETAILED DESCRIPTION

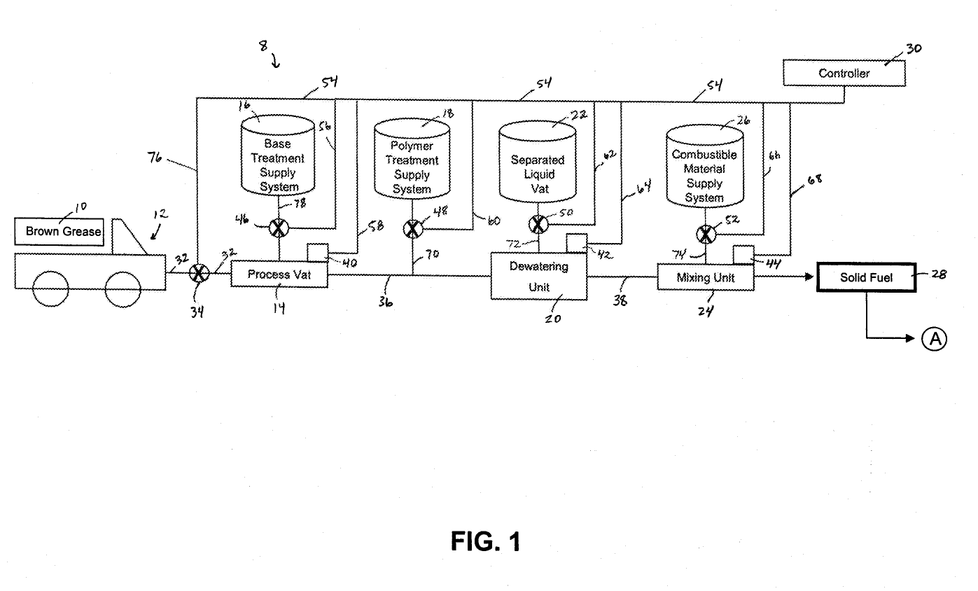

A system 8 for making solid fuel from brown grease in accordance with embodiments of the present invention is illustrated in FIG. 1. The system 8 includes a process vat 14, a base treatment supply system 16, a polymer treatment supply system 18, a dewatering unit 20, a separated liquid vat 22, a mixing unit 24, a combustible material supply system 26, and a processing control system or controller 30, although system 8 could comprise other numbers and types of devices and systems in other configurations. The present invention provides a number of advantages including providing a system and methods for converting brown grease waste into a beneficial solid fuel and for utilizing this solid fuel as a cost-effective energy source for making a fertilizer from sludge.

Referring more specifically to FIG. 1, the process vat 14 is an open container constructed of stainless steel, although other types and numbers of containers which are constructed of other types of materials can be used. The process vat 14 can hold several thousand gallons of brown grease, although the size of the process vat 14 can vary based on the particular application. The process vat 14 is capable of mixing or stirring the contents contained in process vat 14.

A supply line 32 with a valve 34 is connected to the process vat 14 and is used to supply brown grease from a delivery truck 12 to the process vat 14, although other manners of supplying the brown grease to process vat 14 can also be used. The control valve 34 is coupled via signal lines 76 and 54 to the controller 30 which controls the operation of the valve 34 between an open and a closed state to regulate the supply of brown grease being supplied to process vat 14, although other manners for controlling the valve 34 can be used, such as by manually turning the valve 34. Additionally, although in this particular embodiment a supply line 32 and a valve 34 are shown, the supply lines of this and other systems of the invention can comprise other numbers and types of devices, such as filters, pumping devices, and other pipes and valves. Additionally, other types of transfer systems, such as conveyer belts, can be used.

A sensor 40 is connected to the process vat 14 to monitor and detect the pH, temperature, consistency, and other physical and/or chemical properties of the material contained in process vat 14, although other numbers and types of sensing devices that can monitor and detect other properties can be used. Sensor 40 is coupled to processing control system 30 via signal lines 58 and 54 which uses the monitored and detected readings from sensor 40 to control the operation of valves 34 and 46. Controller 30 may also use readings from sensor 40 to control the operation of valve 48, which regulates the transfer of polymer treatment, as described in greater detail below.

Process vat 14 is coupled to base treatment supply system 16 via supply line 78. Base treatment supply system 16 is a container that holds a base treatment (described below) although other types of configurations may also be used. Control valve 46 is positioned in supply line 78 and regulates the transfer of base treatment from base treatment supply system 16. Valve 46 is coupled via signal lines 56 and 54 to the controller 30, which controls the operation of the valve 46 between an open and a closed state to regulate the transfer of base treatment being supplied to process vat 14, although other manners for controlling the valve 46 can be used, such as manually controlling the valve 46.

System 8 includes polymer treatment supply system 18, which is a container that supplies a polymer treatment via supply line 70, although other types of configurations of polymer treatment supply system 18 can be used. Transfer of material through supply line 70 is regulated by valve 48, which is coupled to controller 30 via signal lines 60 and 54 so that controller 30 can control the operation of the valve 48 between an open and closed state to regulate the transfer of polymer treatment to supply line 36. Although a valve 48 whose operation is controlled by controller 30 is shown, other manners for controlling the valve 48 can also be used. In this particular embodiment, polymer treatment from polymer treatment supply system 18 is meter pumped through supply line 70.

Dewatering unit 20 is coupled to process vat 14 to receive material transferred from process vat 14 via supply line 36. Dewatering unit 20 is a system or device capable of separating liquid and solid components of processed brown grease. Suitable dewatering units include units or systems that are well-known by those of ordinary skill in the art for separation procedures and include, without limitation, mechanical separators, chemical separators, and/or thermal separators. Mechanical separators typically involve a centrifuge, a belt filter press, or a gravity dewatering container. Chemical separators employ a chemical reaction between different compounds. Thermal separators heat brown grease to cause evaporation of water content. In this particular embodiment, dewatering unit 20 of system 8 is a centrifuge, although other dewatering units or systems may also be used, such as a gravity dewatering container.

In this particular embodiment, supply line 36, by which material enters dewatering unit 20 for processing, is operably connected to a positive displacement pump with meter control. Supply line 36 may be equipped with one or more valves, as necessary, to control the flow of material from process vat 14 to dewatering unit 20. These valves may be coupled to processing control system 30 which controls the operation of the valves between an open and a closed state to regulate the transfer of material from the process vat 14 to the dewatering unit 20 through supply line 36. Other manners for controlling the valves and/or material flow can be used.

A sensor 42 is connected to the dewatering unit 20 to monitor and detect the consistency (e.g., the % water content) and other physical and/or chemical properties of the material contained in dewatering unit 20. Other numbers and types of sensing devices which can monitor and detect other properties can also be used. Sensor 42 is coupled to processing control system 30 via signal lines 64 and 54. Processing control system 30 uses the monitored and detected readings from sensor 42 to control the operation of valve 50 positioned in supply line 72. The control valve 50 is also coupled to the controller 30, via signal lines 62 and 54, to provide control of the operation of the valve 50 between an open and a closed state to regulate the transfer of separated liquid from dewatering unit 20 to separated liquid vat 22. Separated liquid vat 22 may be connected to a collection source, whereby the liquid is transferred for further processing or disposal. In an alternative embodiment, system 8 may have a supply line leading directly from dewatering unit 20 to a wastewater stream.

System 8 also has a mixing unit 24 which is coupled to dewatering unit 20 via supply line 38. Mixing unit 24 is an industrial strength mixer capable of mixing the dewatered material from dewatering unit 20 with a combustible material from combustible material supply system 26. Combustible material is transferred from combustible material supply system 26 to mixing unit 24 via supply line 74. Mixing unit 24 is, in this particular embodiment, a ribbon mixer, although other types of mixers can be employed. Combustible material supply system 26 is a container that holds combustible material, although other configurations of combustible material supply system 26 can be used. Valve 52 is positioned in supply line 74 and is coupled to processing control system 30 via signal lines 66 and 54, whereby processing control system 30 can operate the open and closed state of valve 52, although other manners of operating valve 52 can be used.

Sensor 44 is connected to mixing unit 24 to monitor and detect the consistency (e.g., the ratio of dewatered brown grease to combustible material) and other physical and/or chemical properties of the material contained in mixing unit 24. Other numbers and types of sensing devices that can monitor and detect other properties can be used. Sensor 44 is coupled to processing control system 30 via signal lines 68 and 54. Processing control system 30 uses the monitored and detected readings from sensor 44 to control the operation of valve 52 and informs the operator of the properties of solid fuel product 28, although the operation of the valve 52 can be controlled in other manners, such as with manual controls.

Processing control system 30 of system 8 is used to control operations in the system 8 for making a solid fuel from brown grease. The processing control system 30 includes a central processing unit (CPU) or processor, a memory, and an interface system which are coupled together by a bus or other link, although other numbers and types of each of the components and other configurations and locations for the components can be used. The processor in the processing control system 30 shown in FIG. 1 executes a program of stored instructions for one or more aspects of the present invention as described herein, including instructions for making a solid fuel from brown grease. The memory stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory in the management server system. The interface system in the processing control system 30 is used to operatively couple and communicate between the processing control system 30 and the valves 46, 48, 50, and 52 and the sensors 40, 42, and 44, although other types of connections to other numbers and types of components which can provide data and/or be controlled could be used.

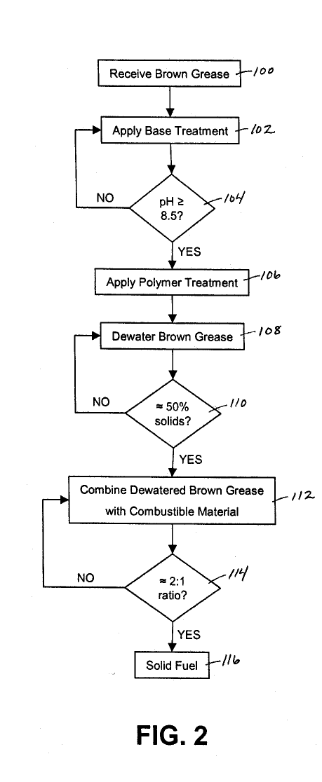

A method for making solid fuel from brown grease in accordance with embodiments of the present invention is illustrated in FIG. 2. The method of the invention is carried out using the system of the invention, including the embodiment illustrated in FIG. 1, although other embodiments or systems can be used in carrying out the method.

In step 100, brown grease, also known as trap grease, is received from a commercial septic hauler that collects brown grease waste from food preparation or food processing facilities. Brown grease is typically collected in these facilities in grease traps, grease interceptors, and other grease collection units, although other sources of brown grease are known and can be used in carrying out the method. In system 8 of FIG. 1, brown grease 10 is received from delivery truck 12 into process vat 14 through supply line 32. Processing control system 30 controls the transfer of brown grease 10 from septic hauler 12 to process vat 14 by regulating the open and closed state of valve 34 in supply line 32. Other manners of transferring brown grease from a delivery truck or other source into processing vat 14 can be used. If necessary, pumps, filters, and/or other transport components may be used to transfer brown grease into system 8. Once the brown grease is received into process vat 14, it is processed immediately, although the grease could be stored and processed at a later time.

In step 102, a base treatment is applied to the brown grease. Applying a base treatment elevates the pH of the brown grease and improves the consistency of the brown grease to facilitate later processing. Brown grease typically has a pH of about 4. When the pH of brown grease is raised to at least about 8.5, the gummy consistency of brown grease is broken down to a slurry, although the threshold to which the pH is raised can be adjusted as necessary. This slurry is more suitable for carrying out later steps of this particular embodiment than the gummier raw brown grease with a lower pH. In system 8 of FIG. 1, base treatment is applied to the brown grease in process vat 14 from base treatment supply system 16 via supply line 78. Processing control system 30 controls the transfer of base treatment through supply line 78 by regulating the open and closed state of valve 46, via signal lines 56 and 54. Other ways of introducing a base treatment into process vat 14 may also be used. In this particular embodiment, base treatment is mixed or stirred with the brown grease contents in process vat 14.

In step 104, it is determined if the brown grease has achieved a pH of greater than or equal to 8.5. Other threshold levels of pH may also be set according to the present method, including pH levels equal to or above about 9.0, 9.5, or 10. Determining the pH of a material is a procedure commonly practiced and known by persons of ordinary skill in the art. In system 8 illustrated in FIG. 1, detection of the pH of the brown grease is determined by sensor 40, which detects and/or monitors, either continually or periodically, the pH of the brown grease and communicates this information to processing control system 30 via signal lines 58 and 54. If processing control system 30 receives a signal from sensor 40 which indicates that the pH of the brown grease is not equal to or greater than the pre-set level (e.g., 8.5, although other pre-set levels could be determined), the “no” branch of step 104 is taken and processing control system 30 maintains valve 46 in an open state to continue to supply base treatment to process vat 14. When processing control system 30 receives a signal that the brown grease in process vat 14 has achieved a pH of equal to or greater than the pre-set value, the “yes” branch is taken and processing control system 30 adjusts valve 46 to a closed state, thus terminating the transfer of base treatment to the brown grease contained in process vat 14.

In step 106, a polymer treatment is applied to the brown grease. Treatment with a polymer solution has the beneficial effect of creating charges in the water and thereby accelerating and increasing separation of water from grease. In this particular embodiment, the brown grease is treated with a cationic emulsion polymer solution, although other suitable polymer treatments are known and can also be used. In system 8 of FIG. 1, polymer treatment is applied to brown grease from polymer treatment supply system 18 via supply line 70. As shown, supply line 70 connects to supply line 36, whereby polymer treatment comes into contact with brown grease as it is being transferred from process vat 14 to dewatering unit 20, although polymer treatment may be applied at other points of processing brown grease in system 8. Processing control system 30 controls the transfer of polymer treatment through supply line 70 by regulating the open and closed state of valve 48, via signal lines 60 and 54 in response to stored amounts in control system 30, although other manners for regulating the amount of polymer treatment applied, such as based on manual control of the valve 48 or based on operator input into the control system 32. Other manners of bringing a polymer treatment in contact with brown grease can be used.

In step 108, the brown grease is dewatered. Dewatering brown grease involves separating the liquid components in brown grease from the solid components. Dewatering may involve separation procedures that are well-known in the art including, without limitation, mechanical separation, chemical separation, and/or thermal separation. In system 8 of FIG. 1, brown grease is transferred out of process vat 14 via supply line 36 to dewatering unit 20, where it is dewatered. Pumps and/or other devices capable of transferring liquid or solid material may be positioned in process vat 14, supply line 36, dewatering unit 20, or any other component of system 8 to transfer the processed brown grease from process vat 14 to dewatering unit 20, and throughout system 8 as necessary. These components can be controlled by processing control system 30 via signal lines, as desired and based on information received by processing control system 30 from the sensors of system 8, although other manners for controlling these components can be used, such as manually controlling one or more of these components.

Liquid that is separated during the dewatering process is transferred out of dewatering unit 20 via supply line 72 into separated liquid vat 22 and is subsequently transferred out of separated liquid vat 22 and disposed of. In an alternative embodiment, separated liquid leaves dewatering unit 20 via a supply line that leads directly to a sewage stream. The transfer of separated liquid out of dewatering unit 20 is controlled by processing control system 30, which regulates the open and closed state of valve 50 via signal lines 62 and 54. As the brown grease is being dewatered, sensor 42 detects and/or monitors the % solid content of the brown grease being dewatered in dewatering unit 20 and relays this information to processing control system 30. Accordingly, the transfer of liquid out of dewatering unit 20 may be automatically controlled by processing control system 30, although other manners of transferring liquid from the dewatering unit can be used, such as be manually controlling valves related to the transfer of the liquid.

In step 110, a determination of whether the dewatered brown grease has achieved approximately a 50% solid content is made. Other % solid content values, including ranges, may be substituted for 50%. In this particular embodiment, the solid content of the dewatered brown grease is 30% solid content or higher, although other ranges may also be suitable. According to the particular embodiment of FIG. 1, the step of determining whether the % solid content of the dewatered brown grease has achieved the desired level is carried out using sensor 42. Sensor 42 detects and/or monitors, either continuously or periodically, the % solid content of the dewatered brown grease and communicates this information to processing control system 30 via signal lines 64 and 54. Determining whether the % solid content of the dewatered brown grease has achieved the desired level can also be carried out in other manners, such as by a manual, visual inspection or with the aid of instruments. In step 110, if it is determined that the dewatered brown grease has not achieved approximately a 50% solid content (or any other pre-determined solid content), the “no” branch is taken and the brown grease is further processed in the dewatering unit. When it is determined that the dewatered brown grease has achieved the desired % solid content, then the “yes” branch is taken in step 110.

In step 112, the dewatered brown grease is combined with a combustible material. Combining dewatered brown grease with a combustible material may be carried out in a mixing unit, such as a ribbon mixer, although other manners of mixing and other types and numbers of mixing units or containers can be used. Combustible materials suitable for carrying out the method include, without limitation, sawdust, wood chips, and combustible trash materials, such as municipal solid waste, paper pulp, and construction and demolition material, although other materials may also be used. Although dewatered brown grease is capable of being used as a fuel, combining the dewatered brown grease with a combustible material may provide the benefit of preventing the build-up of carbon around the edges of the solid fuel which can prevent combustion. The addition of combustible material to the dewatered brown grease provides spacing to allow oxygen into the brown grease fuel to enhance burning and prevent smoldering. In this particular embodiment, mixing is carried out in mixing unit 24 until the combined material achieves a ratio of dewatered brown grease to combustible material of 2:1, by weight or by volume, although other ratios of dewatered brown grease to combustible material may also be used depending on the % solid content of the dewatered brown grease, the type of combustible material selected for combining with the dewatered brown grease, and the intended use.

As illustrated in system 8 of FIG. 1, dewatered brown grease that has achieved the desired ratio of liquid to solid components is transferred out of dewatering unit 20 to mixing unit 24 via supply line 38. In this particular embodiment, supply line 38 is a conveyer belt or any other device capable of transferring solid material, such as a concrete pump or a screw auger. The particular device used to transfer material from dewatering unit 20 to mixing unit 24 may depend on the consistency of the dewatered brown grease.

Combustible material is supplied to mixing unit 24 from combustible material supply system 26, and is transferred via supply line 74. The amount of combustible material entering mixing unit 24 from combustible material supply system 26 is controlled by processing control system 30, which operates the open and closed state of valve 52 via signal lines 66 and 54, although other manners for controlling the valve 52 can be used, such as with manual control. Processing control system 30 operates valve 52 in response to communications received from sensor 44, via signal lines 68 and 54. Sensor 44 detects and/or monitors, either constantly or periodically, the ratio of dewatered brown grease to combustible material in mixing unit 24.

In step 114, a determination is made whether the ratio of dewatered brown grease to combustible material (e.g., 2:1, by weight or volume, although other ratios could be used) has been obtained. In this particular embodiment, a sensor 44 relays information pertaining to the consistency and/or other properties of the brown grease in mixing unit 24 to processing control system 30 via signal lines 68 and 54. Processing control system 30 uses this information to determine whether to further open or close the valve 52 which regulates the transfer of combustible material through supply line 74, although other manners of carrying out this step can be used. If it is determined that the combined dewatered brown grease and combustible material has not achieved the proper ratio, then the “no” branch is taken in step 114 and the amount of combustible material and/or dewatered brown grease is adjusted. When it is determined that the ratio of dewatered brown grease to combustible material has achieved the proper ratio, then the “yes” branch is taken and in step 116 the solid fuel is output.

Solid fuel 28 is a solid fuel capable of generating energy through combustion. If desired, solid fuel 28 can be compressed and/or formed into any desirable shape or size. For example, solid fuel 28 can be in the form of compressed pellets, logs, bricks, or loose piles, although other forms can also be used. In other applications, the solid fuel 28 may be dried in a drier. Supplemental materials may also be added to the dewatered brown grease along with the combustible material to enhance solid fuel 28. Suitable supplemental materials may include combustion enhancers, odor suppressors or enhancers, or any other supplement, as desired.

Accordingly, as described herein the present invention provides a number of advantages, including alternative, cost-effective methods and a system for disposal of brown grease waste. The methods and system of the present invention help meet the demands of disposing of an increasing amount of brown grease waste being generated by food processing and food services facilities, which is particularly significant in view of rising costs associated with brown grease waste disposal. The solid fuel produced by the methods and system of the present invention provide a clean, alternative fuel source. This advantage is particularly significant as oil supplies continue to deplete and demand for energy continues to rise.

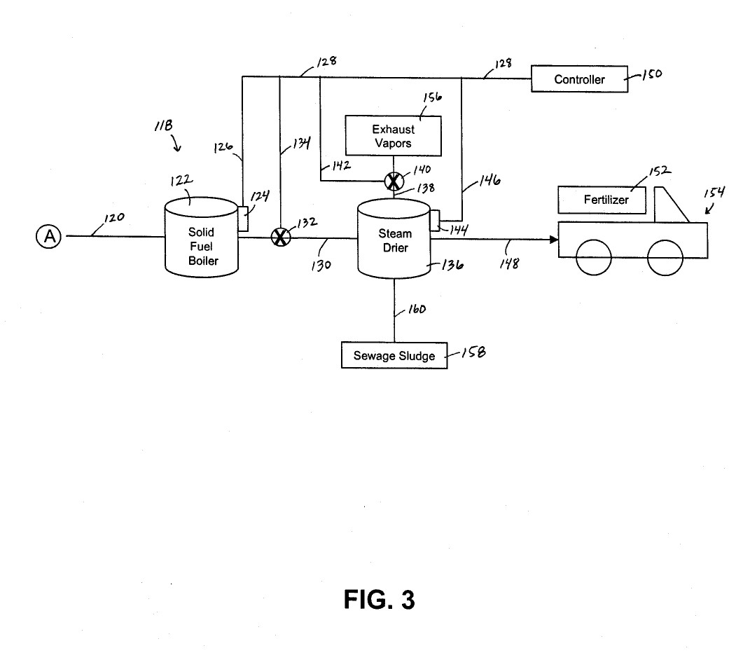

In this particular embodiment, the solid fuel produced by the methods and system of the present invention provides a beneficial fuel source for sewage sludge disposal and methods and systems of recycling sewage sludge into a BioSolid fertilizer material. Thus, another aspect of the present invention relates to a system for making fertilizer material from sewage sludge. Referring to FIG. 3, a system 118 for making a fertilizer material from sewage sludge in accordance with embodiments of the present invention is illustrated. The system 118 includes a solid fuel boiler 122, a steam drier 136, and a processing control system or controller 150, although system 118 could comprise other numbers and types of devices and systems in other configurations. This aspect of the present invention provides a number of advantages including providing a cost-effective method and system for converting sewage sludge waste into a beneficial fertilizer material. In addition, the present invention provides a recycling system for sewage sludge waste that can be operated on the solid fuel of the present invention.

The solid fuel boiler 122 provides system 118 with a source of steam which can be used for drying sewage sludge pursuant to the operation of system 118. Solid fuel boilers rely on solid fuel as a source of energy to produce steam, although other types of fuel, such as liquid and/or gaseous fuel could be used as well. Solid fuel boilers are well known in the art and any solid fuel boiler of industrial strength and capacity can be selected for use in accordance with system 118 of the present invention. Solid fuel boilers are intended to include any type of combustion system or device which uses solid fuel as at least a portion of the energy source.

In this particular embodiment, solid fuel boiler 122 receives solid fuel 28 via supply line 120, although other manners for supplying the fuel can be used. Supply line 120 can be an actual supply line, e.g., a conveyer belt or other tubing or transport system for solid fuel, or supply line 120 can be optional if it is more desirable to manually add solid fuel into solid fuel boiler 122. Solid fuel boiler 122 is equipped with sensor 124, which can monitor and detect conditions within solid fuel boiler 122, such as temperature, although other manners for monitoring the temperature can be used. Sensor 124 is coupled to processing control system 150 via signal lines 126 and 128 which uses the monitored and detected readings from sensor 124 to control valve 132, although other manners for controlling the valve 132 can be used, such as by manually controlling the valve 132. Although signal lines 126 and 128 are shown to couple sensor 124 to controller 150, other manners of coupling this and other units of system 118 to controller 150 and other manners for coupling the controller 30 to valves, sensors, and other components in the earlier embodiment can be used, such as via a wireless communication system.

The steam produced in solid fuel boiler 122 is transferred out of solid fuel boiler 122 into steam drier 136 via supply line 130. Supply line 130 is equipped with valve 132, which regulates the transfer of steam from solid fuel boiler 122 to steam drier 136, although other manners of regulating steam transfer can be used. Valve 132 is coupled to processing control system 150 via signal lines 134 and 128, whereby processing control system 150 regulates the open and closed state of valve 132 in response to signals received from sensor 124. In an alternative embodiment, valve 132 is a manually operated valve.

Steam drier 136 is, in this particular embodiment, an indirect contact dryer in which sewage sludge can be dried with heating surfaces. Depending on the type of dryer, these heating surfaces possess the form of discs, paddles, rolls, and the like, although other types of dryers that use steam can be used. Steam drier 136 receives sewage sludge 158 for drying via supply line 160, although other manners for supplying the sewage sludge can be used. Supply line 160 and the other supply lines of system 118 can be fitted with a valve and/or one or more pumps if desired. Supply line 160 can also be connectable to a sewage sludge supply source at a waste treatment facility, or a delivery truck.

A sensor 144 is connected to steam drier 136 to monitor and detect, continually or periodically, conditions within steam drier 136. In this particular embodiment, the sensor 144, detects the percentage of solid content of the sewage sludge contained in steam drier 136, although other numbers and types of sensing devices that can monitor and detect other conditions can be used. Sensor 144 is coupled to processing control system 150 via signal lines 146 and 128.

In this particular embodiment, the steam drier 136 has a ventilator or blower that sucks away resulting exhaust vapors from within steam drier 136, although other manners for venting exhaust gases can be used. Exhaust vapors 156 exit steam drier 136 via supply line 138, which in the embodiment illustrated in FIG. 3 is equipped with valve 140 to regulate the flow of exhaust vapors 156 from steam drier 136. Valve 140 is coupled to processing control system 150 via signal lines 142 and 128 whereby processing control system 150 regulates the open and closed state of valve 150 in response to information from the sensor 144, although other manners for controlling the valve 140 can be used, such as by manually controlling the valve 140. Dried sewage sludge is removed from steam drier 136 via supply line 148, which is capable of transferring dried sewage sludge as fertilizer 152 to delivery vehicle 154.

Processing control system 150 of system 118 is used to control operations in system 118 for making a fertilizer material from sewage sludge, and has the features described above for the processing control system of the system illustrated in FIG. 1, although other manners for controlling the operation can be used, such as manually controlling operations.

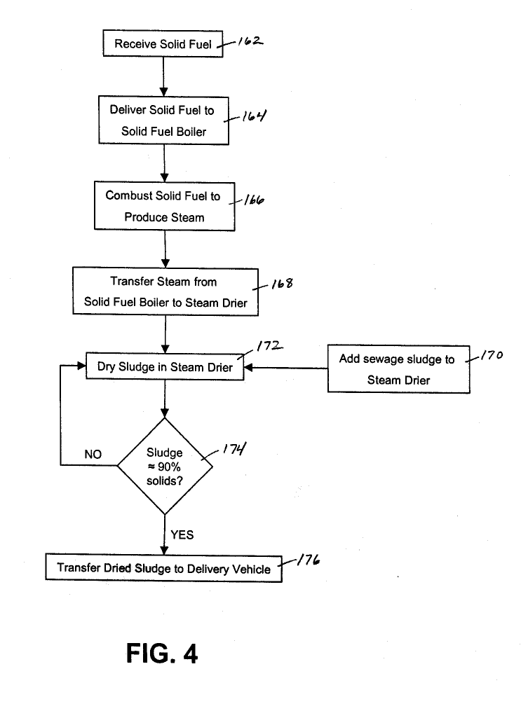

A method for making a fertilizer material from sewage sludge in accordance with embodiments of the present invention will now be described with reference to FIGS. 1-4. In step 162, solid fuel is received, at least a portion of which is solid fuel made from brown grease in accordance with the present invention. In system 118 of FIG. 3, solid fuel 28 is transported from a system 8 of making solid fuel from brown grease of the present invention. It may be desirable for the system 8 of making solid fuel from brown grease of the present invention to be located in close proximity to the system 118 for making a fertilizer material from a sewage sludge of the present invention. This way solid fuel from the system of making solid fuel from brown grease of the present invention can easily be transferred/transported to supply energy for the operation of the system for making a fertilizer material from sewage sludge of the present invention. According to an embodiment, the two systems are coupled and reside in the same treatment plant facility. The present invention provides the advantage of using a system and method for recycling brown grease to produce a solid fuel product that can provide a supply of fuel to a method and system for recycling sewage sludge to make a fertilizer material.

In system 118 of FIG. 3, solid fuel from the methods and system of making a solid fuel from brown grease of the present invention is received into solid fuel boiler 122 through supply line 120. If needed, a valve can be positioned in supply line 120 to regulate the transfer of solid fuel into solid fuel boiler 122. In particular embodiments, supply line 120 is a conveyer belt, auger, or other supply line for transferring solid materials. If necessary, pumps filters, and/or other transport components may be positioned in supply line 120. In an alternative embodiment, supply line 120 signifies a pathway of material transfer, which is carried out manually by shovel or some other transfer system.

In step 164, solid fuel is delivered to a solid fuel boiler where, in step 166, solid fuel is combusted to provide steam. In system 118 illustrated in FIG. 3, solid fuel boiler 122 is equipped with sensor 124, which detects and/or monitors, either continually or periodically, the conditions within solid fuel boiler 122 and relays this information to processing control system 150 via signal lines 126 and 128. For example, sensor 124 may detect and/or monitor the internal temperature of solid fuel boiler 122 and/or provide an indication of the amount and/or temperature of steam being produced by solid fuel boiler 122.

In step 168, steam is transferred from a solid fuel boiler to a steam drier. In system 118 illustrated in FIG. 3, steam is transferred from solid fuel boiler 122 to steam drier 136 via supply line 130. Valve 132 is positioned in supply line 130 to regulate the transfer of steam from solid fuel boiler 122 to steam drier 136. In the embodiment illustrated in FIG. 3, valve 132 is coupled to processing control system 150 via signal lines 134 and 128, whereby the open and closed state of valve 132 is regulated. In this particular embodiment, the open and closed state of valve 132 is regulated by processing control system 150 in response to signals received from sensor 124 via signal lines 126 and 128.

In step 170, sewage sludge is added to a steam drier where, according to step 172 of the method, sewage sludge is dried. In system 118 illustrated in FIG. 3, sewage sludge 158 is transferred to steam drier 136 via supply line 160. Sewage sludge is typically obtained directly from a wastewater treatment facility, or from a delivery truck. Steam supplied to steam drier 136 via supply line 130 is applied to heating surfaces of steam drier 136, which may be in the form of discs, paddles, rolls, and the like. Sewage sludge 158 can be applied to the heating surfaces in a thin layer and then be abrased or scraped off, or the heating surfaces can be moved or stirred in sewage sludge 158. Other techniques of drying using steam can be used. Typically, the heating surfaces are steam-heated heating surfaces that heat the sludge until the moisture contained in the sludge evaporates. In this particular embodiment, steam drier 136 is a steam paddle drier.

According to an embodiment, steam drier 136 has a ventilator or blower that sucks away resulting exhaust vapors 156, via supply line 138. As illustrated in FIG. 3, valve 140 may be positioned in supply line 138 to regulate the transfer of exhaust vapors 156 from steam drier 136. Processing control system 150 regulates the open and closed state of valve 140 via signal lines 142 and 128 in response to signals received from sensor 144 via signal lines 146 and 128. In an alternative embodiment, valve 140 is a manually operated valve.

In step 174, it is determined whether the sewage sludge in the steam drier has obtained a % solid content (e.g., about 90% solids, or any other suitable amount). If the sewage sludge in the steam drier has not obtained the desired % solid content, the “no” branch is taken and the sewage sludge remains in the steam drier for further drying. If the sewage sludge in the steam drier has obtained the desired % solid content, the “yes” branch is taken and the dried sludge is transferred to a delivery vehicle in step 176. In system 118 illustrated in FIG. 3, sensor 144 is used to monitor and/or detect whether the sewage sludge in steam drier 136 has reached the desired amount of % solids. When the sewage sludge in steam drier 136 reaches the desired amount of % solids, it can be transferred out of system 118 via supply line 148. The dried sewage sludge is then in the form of fertilizer material 152, which can be loaded onto vehicle 154 and transported to a suitable site for land application as a Biosolid fertilizer. In this particular embodiment, the fertilizer is a class A Biosolid fertilizer.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method of making a fertilizer material from sewage sludge, said method comprising:
providing sewage sludge;
providing steam generated by combusting a fuel comprising brown grease; and
contacting the sewage sludge with the steam under conditions effective to dewater the sewage sludge and render a fertilizer material.

2. The method according to claim 1, wherein the fuel comprises:
dewatered brown grease and
a combustible material.

3. The method according to claim 1, wherein said contacting is carried out in a steam paddle dryer.

4. The method according to claim 1, wherein the sewage sludge is dewatered to contain a minimum of about 90% solids.

5. The method according to claim 1, wherein the fertilizer material is a class A Biosolid fertilizer.

6. The method according to claim 1 further comprising combining ash generated from the combusted fuel with the fertilizer material.

7. A system for making fertilizer material from sewage sludge, said system comprising:
a system for making solid fuel from brown grease, said system comprising a dewatering unit capable of dewatering brown grease under conditions effective to make a solid fuel;
a solid fuel boiler capable of combusting solid fuel from the system for making solid fuel to generate steam; and
a steam dryer for dewatering sewage sludge, wherein the steam dryer is coupled to the solid fuel boiler, whereby steam from the solid fuel boiler contacts the steam dryer thereby dewatering sewage sludge contained in the steam dryer to render a fertilizer material.

8. The system according to claim 7, wherein the dewatering unit comprises at least one of a mechanical separator, a chemical separator, and a thermal separator.

9. The system according to claim 7, wherein the system for making solid fuel from brown grease further comprises a mixing unit capable of combining dewatered brown grease with a combustible material.

10. The system according to claim 7, wherein the steam dryer is a paddle steam dryer.
